(19) United States
(12) Patent Application Publication
(10) Pub. No.: US 2021/0000295 A1
(43) Pub. Date: Jan. 7, 2021

(54) ADAPTABLE COOKING GRATE CONFIGURATION

(71) Applicant: W.C. BRADLEY CO., Columbus, GA (US)

(72) Inventors: ANTHONY HAMILTON, Hamilton, GA (US); RAMIN KHOSRAVI RAHMANI, Columbus, GA (US); BRUCE ROBERTS, Phenix City, AL (US); MALLIK AHMED, Columbus, GA (US); SLEIMAN ABDALLAH, Columbus, GA (US)

(21) Appl. No.: 16/921,437

(22) Filed: Jul. 6, 2020

Related U.S. Application Data
(60) Provisional application No. 62/870,466, filed on Jul. 3, 2019.

(51) Int. Cl. A47J 37/07

(52) U.S. Cl. CPC A47J 37/0786; A47J 2037/0795; A47J 37/0704

(57) ABSTRACT

A cooking grate has a first, central grate portion having opposed front and back support edges for engaging with a support ledge in a grill firebox, and second and third side flanking grate portions each with front and rear support edges for engaging with the support ledge.

### CROSS-REFERENCE TO RELATED CASES

This application claims the benefit of U.S. provisional patent application Ser. No. 62/870,466, filed on Jul. 3, 2019, and incorporates such provisional application by reference into this disclosure as if fully set out at this point.

### FIELD OF THE INVENTION

This disclosure relates to cooking grill in general and, more specifically, to an adaptable cooking grate for use with a cooking grill.

### BACKGROUND OF THE INVENTION

Outdoor cooking appliances with various types of heat sources typically have cooking grates placed above the heat source, and may have a removable or movable lid. A cooking grate may comprise a number of bars or ribs of a suitable heat-resistant, food contact approved material. The cooking grate or cooking surface may also comprise a solid planar surface or griddle, or have a more complex arrangement of individual elements. Cooking may occur by a conduction, convection, radiation, and/or combinations of these. On smaller size grills, the cooking grate may be made in a single piece by an appropriate manufacturing method such as casting, stamping, welding, or some combination of methods. On larger size grills this cooking grate may be made of several pieces to reduce weight for ease of handling. Such multipiece grates are made of several elements more or less identical in form and function, if not in size.

Systems of the prior art are limited with respect to adjustments, changes, or alterations that may be available on the cooking grate including the use of alternate cooking surfaces, shapes, textures, or inserts.

What is needed is a system and method for addressing the above and related concerns.

### SUMMARY OF THE INVENTION

The invention of the present disclosure, in one aspect thereof, comprises a cooking grate including a first, central grate portion having opposed front and back support edges for engaging with a support ledge in a grill firebox, and second and third side flanking grate portions with each with front and rear support edges for engaging with the support ledge. Opposed side edges of the first, central grate form arcuate sections that are received into complementary arcuate medial spans of the second and third side flanking portions.

In some embodiments, the side edges of the first, central grate each form an arc of a circle. The complementary arcuate medial spans of the second and third side flanking portions may each form an arc of a circle. The first, second, and third grate portions together may form a rectangular cooking grate. The first grate portion may comprise perforations therethrough that have a pattern differing from a pattern of perforations through the second and third grate portions. In some embodiments, the first grate portion comprises a non-perforated griddle, or a pan.

In some cases, the accurate medial portions of the second and third side flanking grate portions comprise a lower inwardly projecting ledge. The first central grate portion may rest on the arcuate portions of the second and third side flanking grate portions. In some embodiments, the first, central grate portion further comprises a projection proceeding from each of the accurate sections on opposite sides of the first, central grate portion to rest on the respective second and third side flanking grate portions.

The invention of the present disclosure, in another aspect thereof, comprises a cooking grate kit having a pair of side portions, each having a cooking grate surface defined between front and rear support edges, outer straight edges, and inner arcuate edges, the front and rear support edges of each adapted to engage a respective front and rear support ledge in a grill firebox. The kit includes a first, inner insert defining a cooking surface of a first type shaped to fit between the pair of side portions when they are spaced apart within the firebox and engaged with the support ledge, the first, inner insert having opposite sides that are of a cooperating shape with the inner accurate edges of the pair of side portions and having front and back support edges for engaging with the respective support ledges of the firebox.

In some embodiments, the front and back support edges of the first, inner insert are straight. The inner accurate edges of the pair of side portions may comprise a circle arc. The inner arcuate edges of the pair of side portions may comprise inwardly projecting ledges.

The cooking grate kit of may further comprise a second, inner insert having a cooking surface of a second type. The cooking surface of the first type may comprise a perforated grate and the cooking surface of the second type may comprise a non-perforated cooking surface.

The invention of the present disclosure, in another aspect thereof, comprises a grill having a firebox containing a heat source and first and second support ledges suspended in the firebox above the heat source. The grill includes a pair of spaced apart cooking grate portions that engage with the support ledges and are suspended above the heat source, the pair of spaced apart cooking grate portions defining a non-rectangular space therebetween at the level of the first and second support ledge. The grill also includes a first central cooking grate insert sized to fit the non-rectangular space such that food cannot fall between the first central cooking grate insert and either of the pair of spaced apart cooking grate portions.

In some embodiments, the first central cooking grate insert comprises support edges that engage with the front and rear support ledges of the firebox. The first central cooking grate insert may comprise a first cooking grate pattern that differs from a second cooking grate pattern of the pair of spaced apart cooking grate portions. In some cases, the grill includes a second central cooking grate insert sized to fit the non-rectangular space and providing a non-perforated cooking surface.

### BRIEF DESCRIPTION OF THE DRAWINGS

FIG. 1 is an overhead view of a cooking grate with removeable insert.

FIG. 2 is an overhead view of a cooking grate with removeable insert according to aspects of the present disclosure.

FIG. 3 is an overhead perspective view of a cooking grate insert according to aspects of the present disclosure.

FIG. 4 is a perspective view of a cooking grate with removable griddle insert according to aspects of the present disclosure.

FIG. 5 is a perspective view of a cooking grate with removable pan insert according to aspects of the present disclosure.

FIG. 6 is a close-up perspective view of a cooking grill utilizing a cooking grate with removeable insert according to aspects of the present disclosure.

### DETAILED DESCRIPTION OF THE PREFERRED EMBODIMENTS

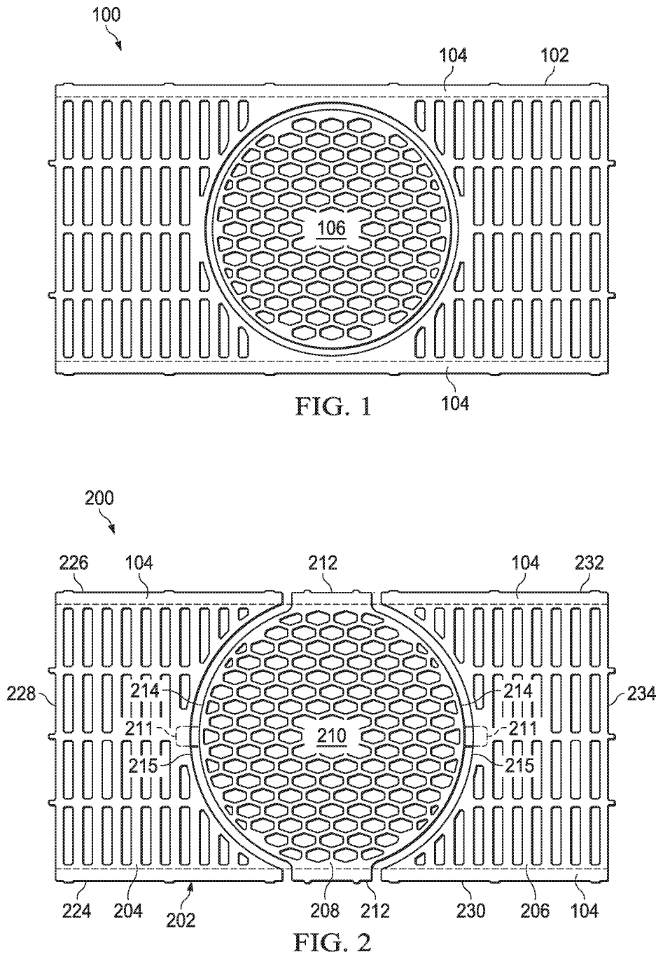

Referring now to FIG. 1, an overhead view of a cooking grate 100 with removeable insert 106 is shown. The insert 106 is round and set into the cooking grate 102 and supported by an appropriate flange or tab mechanism between the insert 106 and the main grate 102 such that the insert 106 is supported by the main grate 102 itself. The cooking grate 102 is normally supported on some type of ledge structure (here, ledges 104) in the main body of the cooking appliance, which contains below the grate 100 the heat source or sources.

As can be seen in FIG. 1, the diameter of the round insert 106 in the grate 102 is constrained by the requirement of having enough material in the main cooking grate 102 surrounding the insert 106 to provide adequate strength when main cooking grate 102 is handled with the insert 106 not in place. The effect of this is significant. For example, if the depth of the main grate 102 is 18″ front to back a minimum of 1 inch of material may be required to the front and rear of the insert 106 for adequate strength. If the nominal diameter of the insert 106 is 16″, the area is 201 square inches. On the other hand, if the diameter of the insert 106 could be 18″ to take advantage of the full length between the ledges 104 then its nominal area would be 254 square inches. This represents a substantial increase of over 25% in useable area of the insert 106.

Referring now to FIG. 2 an overhead view of a cooking grate 200 with removeable insert 210 according to aspects of the present disclosure is shown. The cooking grate 200 comprises a split main grate 202 and a separately supported insert 208 (e.g., the insert 208 is supported by the ledges 104 rather than the remainder of the grate 200). In the illustrated embodiment, the main grate 202 has a left portion 202 and a right portion 206 that flank the insert 208. The insert 208 may have a body 210 that is substantially or partially circular except where support edges 212 are defined. The body 210 comprises arced edges 214 spanning front to back to meet with support edges 212. The body 210 may be planar in shape but also include various ribs, cross hatches, or other patterns formed from openings or perforations in the body to pass convective heat and to drain grease and other droppings. Any pattern, crosshatching, or the like on the body 210 may complement or contrast with such features on the left and right portions 204, 206. In some embodiments the body 210 comprises a solid surface (i.e., non-perforated) such as a griddle. In some embodiments, the grate 200 comprises a plurality of different inserts (e.g., such as insert 208) that may be exchanged to adjust cooking characteristics or appearance of cooked food.

The left and right portions 204, 206 of the grate 200 may form straight edges 228, 224, respectively, on left and right edges of the cooking grate 200. Support edges (224, front, and 226 rear for left portion 204; 230, front, and 232, rear for right portion 206) may engage with the ledges 104 for suspending the respective left and right portions 204, 206 over the heat source. Inner and medial spans 215 of the left and right portions 204, 206 of the grate 200 are curved or otherwise contoured to match the shape of the arced edges 214 body 210 of the insert 208. The edges 214 may overlap, or be overlapped by, the medial spans 215. In other embodiments the edges 214 and medial spans 215 are on a same level, either touching or somewhat spaced apart (but close enough to prevent food loss through the grate 200).

The insert 208 may be stable as a component of the cooking grate 200 by virtue of its contact with the ledges 104 as previously described. However, the shape of the insert 208 and the left and right portions 204, 206 can serve to prevent the insert 208 from be inserted at an incorrect angle such that the support edges 212 do not contact the ledges 104 resulting in the insert 108 falling into the firebox (e.g., the support edges 212 may contact the left or right portions 204, 206 such that the insert 208 does not sit flush, but may yet be prevented from falling into the firebox).

The improved system as illustrated in FIG. 2 allows the insert 208 to be made at a nominal diameter equal to the depth of the main grate 200 (e.g., front to rear) by separating the main grate 200 into two pieces 204, 206 on either side of the insert 208. The insert 208 has flanges or the support edges 212 that use the same ledge structure 104 in the main body (e.g., firebox) of the cooking appliance that is used to support the main cooking grate pieces 204, 206. In some embodiments, two or more stabilizing elements 211 (shown in phantom) are provided on the insert 208 and contact the main grate (the left and right portions 204, 206) along a lateral centerline of the main grate 200 extending from side to side. In such embodiments, weight of the insert 208 is primarily born at the ledges 104 but additional stability (and possibility of weight-bearing) is provided by the grate pieces 204, 206.

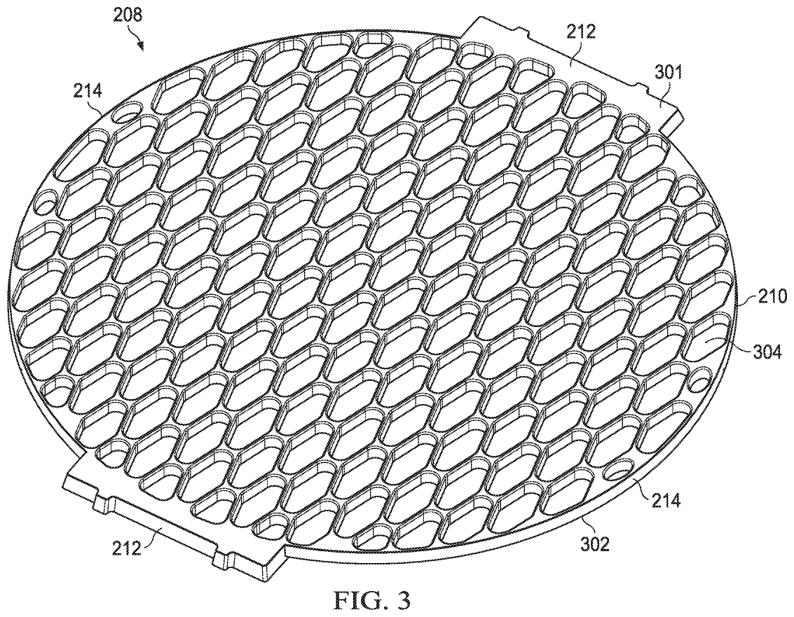

FIG. 3 is an overhead perspective view of a cooking grate insert 208 according to aspects of the present disclosure. The insert body 210 may be generally planar although it has a thickness according to the material of which it is constructed (e.g., steel, cast iron, etc.). Accordingly, the body 210 may be said to comprise an upper side 301 spaced apart from a bottom side 302 by the thickness of the insert body 210. Perforations or holes 304 may be defined in the body 210 to pass from one side 301 to the other 302. It is the perforations 304 that allow hot cooking gases to flow through the insert 208 to reach food being cooked thereon. Perforations 304 also allow grease and other cooking by products to drain away. The perforations 304 may comprise a repeating pattern, a decorative shape, or other desired effect. This may or may not match the pattern of the remainder of the grate 200. By changing inserts (e.g., 208) for one of another pattern, different cooking effects may be achieved. An insert may also be selected for its particular “cross hatching” effect on cooked food.

As can also be seen in FIG. 3, the insert 208 may be formed in generally-circular configuration, but the “circle” may be extended all the way to the front and back of the associated cooking grate since the insert 208 utilizes flanges 212 to rest in the appropriate location rather than engaging only with the rest of the grate (as in FIG. 1).

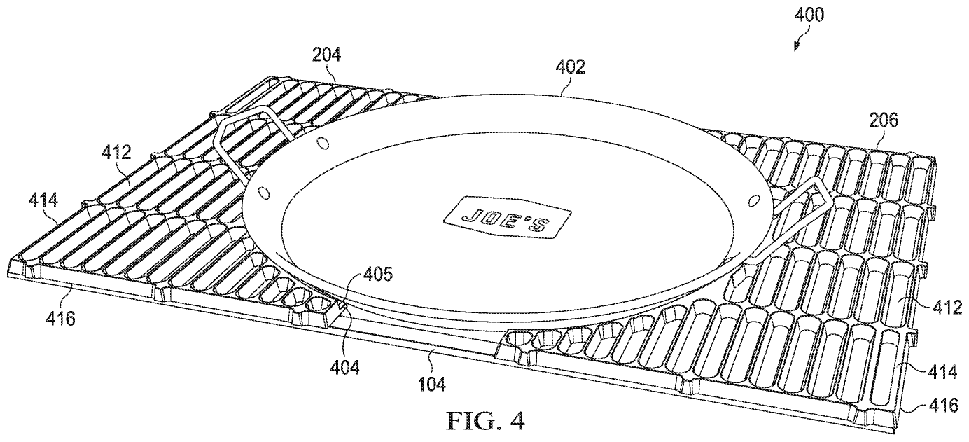

Referring now to FIG. 4, a perspective view of a cooking grate 400 with removable griddle insert 402 according to aspects of the present disclosure is shown. The cooking gate 400 comprises left grate portion 204 and right grate portion 206, as discussed above. The grate portions 204, 206 may be generally planar but have a thickness according to the material from which they are constructed (e.g., steel, cast iron, etc.). Accordingly, both the left portion 204 and right portion 206 may be said to comprise respective upper side 414 spaced apart from bottom sides 316 by the thickness of the grate portions 204, 206. Perforations or holes 412 may be defined in the grate portions 204, 206. Here again, the perforations 412 allow hot cooking gases to flow through the grate portions 204, 206 to reach food being cooked thereon and allow grease and other by products to drain away. The perforations 412 may comprise a repeating pattern, a decorative shape, or other desired effect. The pattern of holes or perforations 412 on the grate portions 204, 206 may differ from one another and/or from the pattern of the grate insert 208 (e.g., FIG. 2).

Here, as shown in FIG. 4, the insert 402 is a shallow griddle that allows for cooking food when the recipe or preparation method calls for a griddle. The left and right portions 204, 206 remain available for grilling. The insert 402 may rest upon inward facing ledges (404) on the left and right portions 204, 206. Inward facing ledges 404 may be bound by a peripheral wall 405 that serves to positively locate the insert 402. The griddle 402 may or may not contact the ledges 104 associated with the firebox itself.

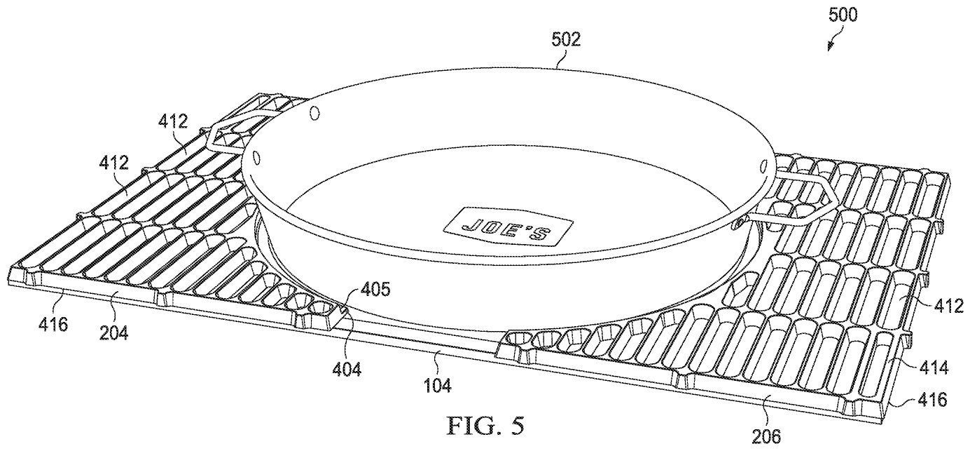

Referring now to FIG. 5, a perspective view of a cooking grate 500 with removable pan insert 502 according to aspects of the present disclosure is shown. The cooking gate 500 comprises left portion 204 and right portion 206, as discussed above. Here the insert 502 is a pan that allows for cooking food when the recipe or preparation method calls for use of a pan. The pan insert 502 may be deeper or shallower than shown to accommodate different types of recipes or preparations. In some embodiments, the pan insert 502 remains short enough that a lid (not shown) of the grill where it is used may be closed. The pan insert 502 may or may not have a lid of its own.

The left and right portions 204, 206 remain available for grilling. The insert 502 may rest upon inward facing ledges (404) on the left and right portions 204, 206 and may be bound from movement by the wall 405. The griddle 502 may or may not contact the ledges 104 associated with the firebox.

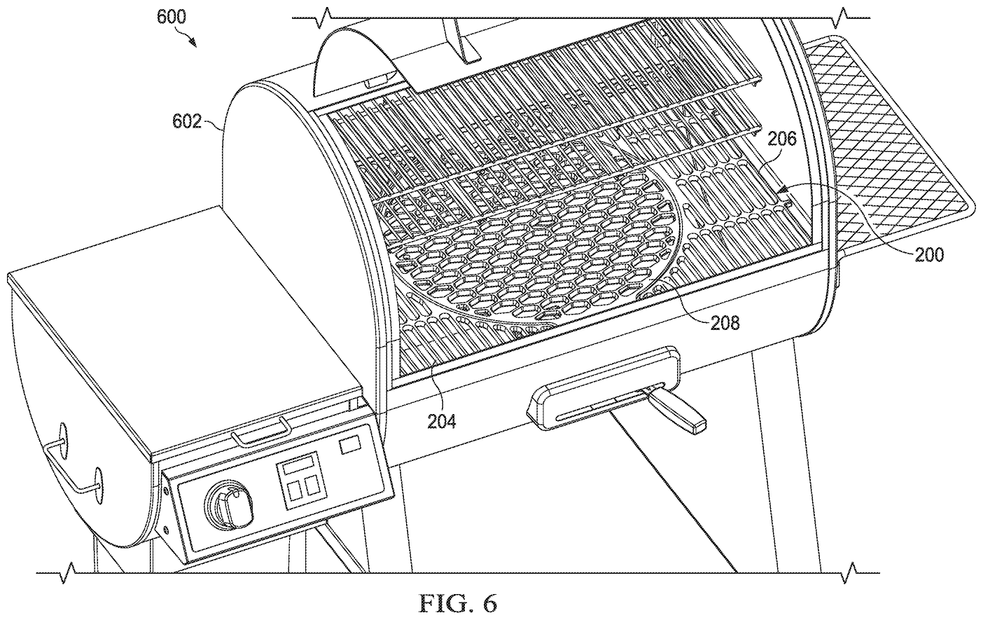

Referring now to FIG. 6, a close-up perspective view of a cooking grill 600 utilizing a cooking grate 200 with removeable insert 208 according to aspects of the present disclosure is shown. Here the cooking grill 600 can be seen to comprise a firebox 602 which supports the cooking grate 200 relative to a heat source (inside the firebox, comprising a solid fuel combustion source and/or gas). The central location of the large insert 208 can be seen with left portion 204 and right portion 206 of the grate 200 on either side. It should be understood that the width and depth of the cooking grate 200 can vary. Additional sections of cooking grate may also be utilized within the grill 600 (for example, additional rectilinear segments of grate to the left or right of the cooking grate 200 as illustrated, where the grill size warrants). Insert 208 may be interchangeable with inserts 402 and 502 described above, or others.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

1. A cooking grate comprising:
a first, central grate portion having opposed front and back support edges for engaging with a support ledge in a grill firebox; and
second and third side flanking grate portions, each with front and rear support edges for engaging with the support ledge;
wherein opposed side edges of the first, central grate form arcuate sections that are received into complementary arcuate medial spans of the second and third side flanking portions.

2. The cooking grate of claim 1, wherein the side edges of the first, central grate each form an arc of a circle.

3. The cooking grate of claim 2, wherein the complementary arcuate medial spans of the second and third side flanking portions each form an arc of a circle.

4. The cooking grate of claim 3, wherein the first, second, and third grate portions together form a rectangular cooking grate.

5. The cooking grate of claim 4, wherein the first grate portion comprises perforations therethrough that have a pattern differing from a pattern of perforations through the second and third grate portions.

6. The cooking grate of claim 4, wherein the first grate portion comprises a non-perforated griddle.

7. The cooking grate of claim 4, wherein the first grate portion comprises a pan.

8. The cooking grate of claim 1, wherein the accurate medial portions of the second and third side flanking grate portions comprise a lower inwardly projecting ledge.

9. The cooking grate of claim 1, wherein the first central grate portion rests on the arcuate portions of the second and third side flanking grate portions.

10. The cooking grate of claim 9, wherein the first, central grate portion further comprises projection proceeding from each of the accurate sections on opposite sides of the first, central grate portion to rest on the respective second and third side flanking grate portions.

11. A cooking grate kit comprising:
a pair of side portions, each having a cooking grate surface defined between front and rear support edges, outer straight edges, and inner arcuate edges, the front and rear support edges of each adapted to engage a respective front and rear support ledge in a grill firebox; and
a first, inner insert defining a cooking surface of a first type shaped to fit between the pair of side portions when they are spaced apart within the firebox and engaged with the support ledge, the first, inner insert having opposite sides that are of a cooperating shape with the inner accurate edges of the pair of side portions and having front and back support edges for engaging with the respective support ledges of the firebox.

12. The cooking grate kit of claim 11, wherein the front and back support edges of the first, inner insert are straight.

13. The cooking grate kit of claim 12, wherein the inner accurate edges of the pair of side portions comprise a circle arc.

14. The cooking grate kit of claim 13, wherein the inner arcuate edges of the pair of side portions comprise an inwardly projecting ledges.

15. The cooking grate kit of claim 14, further comprising a second, inner insert having a cooking surface of a second type.

16. The cooking grate kit of claim 15, wherein the cooking surface of the first type comprises a perforated grate and the cooking surface of the second type comprises a non-perforated cooking surface.

17. A grill comprising:
a firebox containing a heat source and first and second support ledges suspended in the firebox above the heat source;
a pair of spaced apart cooking grate portions that engage with the support ledges and are suspended above the heat source, the pair of spaced apart cooking grate portions defining a non-rectangular space therebetween at the level of the first and second support ledge; and
a first central cooking grate insert sized to fit the non-rectangular space such that food cannot fall between the first central cooking grate insert and either of the pair of spaced apart cooking grate portions.

18. The grill of claim 17, wherein the first central cooking grate insert comprises support edges that engage with the front and rear support ledges of the firebox.

19. The grill of claim 18, wherein the first central cooking grate insert comprises a first cooking grate pattern that differs from a second cooking grate pattern of the pair of spaced apart cooking grate portions.

20. The grill of claim 18, further comprising a second central cooking grate insert sized to fit the non-rectangular space and providing a non-perforated cooking surface.
